(19) United States
(12) Patent Application Publication
(10) Pub. No.: US 2023/0259118 A1
(43) Pub. Date: Aug. 17, 2023

(54) NETWORK UNIT, MAINTENANCE SYSTEM, NON-TRANSITORY COMPUTER READABLE MEDIUM, AND ENERGY STORAGE DEVICE DATA TRANSMISSION METHOD

(71) Applicant: GS Yuasa International Ltd., Kyoto (JP)

(72) Inventor: Tomikatsu UCHIHORI, Kyoto (JP)

(73) Assignee: GS Yuasa International Ltd., Kyoto (JP)

(21) Appl. No.: 18/013,251

(22) PCT Filed: Jun. 4, 2021
(86) PCT No.: PCT/JP2021/021380

§ 371 Date: Dec. 28, 2022

(30) Foreign Application Priority Data
Jun. 29, 2020 (JP) 2020-111718

(51) Int. Cl. G05B 23/02

(52) U.S. Cl. CPC G05B 23/0283

(57) ABSTRACT

A network unit includes: a first communication unit that receives state data from a unit that measures a state of an energy storage device; a second communication unit that performs communication via a specific network; a third communication unit that performs communication via a communication medium different from the specific network; an operation unit including a changeover switch; and a control unit that controls communication by the first to third communication units, in which the control unit transmits the state data from the second communication unit according to a setting in the specific network according to a state of the changeover switch, and in which when the network unit is activated with the changeover switch being in a predetermined state, the control unit performs communication connection with a specific communication device by the third communication unit.

### TECHNICAL FIELD

The present invention relates to maintenance of a system including an energy storage device, and relates to a network unit, a maintenance system, a computer program, and an energy storage device data transmission method that facilitate maintenance work.

### BACKGROUND ART

To operate a system including an energy storage device, it is essential to take preventive maintenance measures including periodic inspections. During the inspection, a maintenance worker acquires measurement data of the energy storage device from a monitoring unit attached to a plurality of energy storage devices included in the system.

Patent Document 1 discloses that a network unit is connected to a system so that a maintenance worker can easily acquire data. The network unit includes a communication unit for a management network for transmitting data to a management computer, and a wireless communication unit for a wireless communication line independent of the management network. The maintenance worker communicably connects the brought information terminal to the network unit via the wireless communication unit. The information terminal can acquire data stored in the system via the wireless communication line.

### PRIOR ART DOCUMENT

### Patent Document

Patent Document 1: JP-A-2018-201331

### SUMMARY OF THE INVENTION

### Problems to be Solved by the Invention

The wireless communication connection between the network unit connected to the system and the information terminal of the maintenance worker is required to have a high level of safety. Inspection work at the installation place of the energy storage device requires ensuring safety by time restriction and the presence of the customer. A method for more safely and smoothly connecting communication between the network unit and the information terminal of the maintenance worker is required.

An object of the present invention is to provide a network unit, a maintenance system, a computer program, and an energy storage device data transmission method.

### Means for Solving the Problems

A network unit includes: a first communication unit that receives state data from a unit that measures a state of an energy storage device; a second communication unit that performs communication via a specific network; a third communication unit that performs communication via a communication medium different from the specific network; an operation unit including a changeover switch; and a control unit that controls communication by the first to third communication units, in which the control unit transmits the state data from the second communication unit according to a setting in the specific network according to a state of the changeover switch, and in which when the network unit is activated with the changeover switch being in a predetermined state, the control unit performs communication connection with a specific communication device by the third communication unit.

### BRIEF DESCRIPTION OF THE DRAWINGS

FIG. 1 illustrates an outline of a system to be maintained.

FIG. 2 illustrates an appearance of a network unit.

FIG. 3 is a block diagram illustrating a configuration of a network unit.

FIG. 4 is a block diagram illustrating a configuration of a maintenance terminal device.

FIG. 5 illustrates examples of connection modes.

FIG. 6 is a flowchart illustrating an example of a processing procedure of the network unit.

FIG. 7 is a flowchart illustrating an example of a procedure of communication processing in a fourth connection mode.

### MODE FOR CARRYING OUT THE INVENTION

A network unit includes: a first communication unit that receives state data from a unit that measures a state of an energy storage device; a second communication unit that performs communication via a specific network; a third communication unit that performs communication via a communication medium different from the specific network; an operation unit including a changeover switch; and a control unit that controls communication by the first to third communication units, in which the control unit transmits the state data from the second communication unit according to a setting in the specific network according to a state of the changeover switch, and in which when the network unit is activated with the changeover switch being in a predetermined state, the control unit performs communication connection with a specific communication device by the third communication unit.

With the above configuration, the specific communication device carried by a maintenance worker performs communication connection with the network unit via the third communication unit only when the maintenance worker activates the network unit by setting the changeover switch to the predetermined state. Even if the third communication unit used with the specific communication device is disabled, the network unit forcibly transitions to a state in which communication connection with a maintenance terminal device which is the specific communication device is possible. The network unit can be forcibly communicably connected to the maintenance terminal device without interfering with the communication while the communication is being performed by the second communication unit using the customer's network.

The changeover switch may be, for example, a plurality of dip switches. A plurality of states other than the predetermined state can be set by a combination of states of the plurality of dip switches. A plurality of variations of communication connection in a specific network using wired communication and/or wireless communication and communication connection with the maintenance terminal device can be set.

The maintenance worker can take in the state data of the energy storage device into the maintenance terminal device by a simple operation of operating the changeover switch and activating the network unit. The maintenance worker does not need to connect the maintenance terminal device to the customer's network. This enables safe and smooth maintenance work.

The operation unit of the network unit may include a reset button that causes interruption to the control unit, and the control unit may determine whether or not the state of the changeover switch is the predetermined state every time interruption occurs by pressing of the reset button.

With the above configuration, the maintenance worker can take in the state data of the energy storage device into the maintenance terminal device by a simple operation of setting the changeover switch to the predetermined state and pressing the reset button.

When a predetermined timeout period has elapsed after the network unit is activated with the changeover switch being in the predetermined state, the control unit may transition to a state of performing communication according to the setting by the second communication unit.

With the above configuration, the maintenance worker is allowed to forget to return the changeover switch to the original state after the work of taking the state data of the energy storage device into the maintenance terminal device. Even when the changeover switch is kept in the predetermined state, the network unit can resume the transmission of the state data by the second communication unit according to the setting.

When the network unit is activated with the changeover switch being in the predetermined state, the control unit may cause the third communication unit to function as an access point to communicably connect to with a communication device that transmits a valid password.

With such a configuration, when the maintenance terminal device securely stores a valid password in the network unit, it is possible to execute work of taking the state data of the energy storage device into the maintenance terminal device by a simple operation without being connected to the network of the customer.

A maintenance system includes a network unit that receives state data from a unit that measures a state of an energy storage device by a first communication unit and transmits the state data to another unit, and a maintenance terminal device including a communication unit that performs communication connection with the network unit. The network unit includes: a second communication unit that performs communication via a specific network; a third communication unit that performs communication via a communication medium different from the specific network; an operation unit including a changeover switch; and a control unit that controls communication by the first to third communication units. The control unit transmits the state data from the second communication unit or the third communication unit according to a setting in the specific network according to a state of the changeover switch. Only when the network unit is activated with the changeover switch being in a predetermined state, the control unit performs communication connection with the maintenance terminal device by the third communication unit without following the setting, and transmits the state data to the maintenance terminal device.

A computer program is executed by a computer including a communication unit that performs communication via a wired communication line and/or a wireless communication medium, and an operation unit including a changeover switch. The computer program causes the computer to execute the processing of: while receiving state data from a unit that measures a state of an energy storage device, transmitting the state data from the communication unit according to a setting in a specific network according to a state of the changeover switch; performing communication connection with a specific communication device via a communication medium different from the specific network without following the setting only when the network unit is activated with the changeover switch being in a predetermined state; and transmitting the state data to the specific communication device.

An energy storage device data transmission method is a method in which a network unit including a communication unit that performs communication via a wired communication line and/or a wireless communication medium, and an operation unit including a changeover switch receives state data from a unit that measures a state of an energy storage device and transmits the state data to another unit. The energy storage device data transmission method includes the processing of, by the network unit: transmitting the state data from the communication unit to the specific network according to a setting in a specific network according to a state of the changeover switch; performing communication connection with a specific communication device via a communication medium different from the specific network without following the setting when the network unit is activated with the changeover switch being in a predetermined state; and transmitting the state data to the specific communication device.

The present invention will be specifically described with reference to the drawings showing an embodiment thereof.

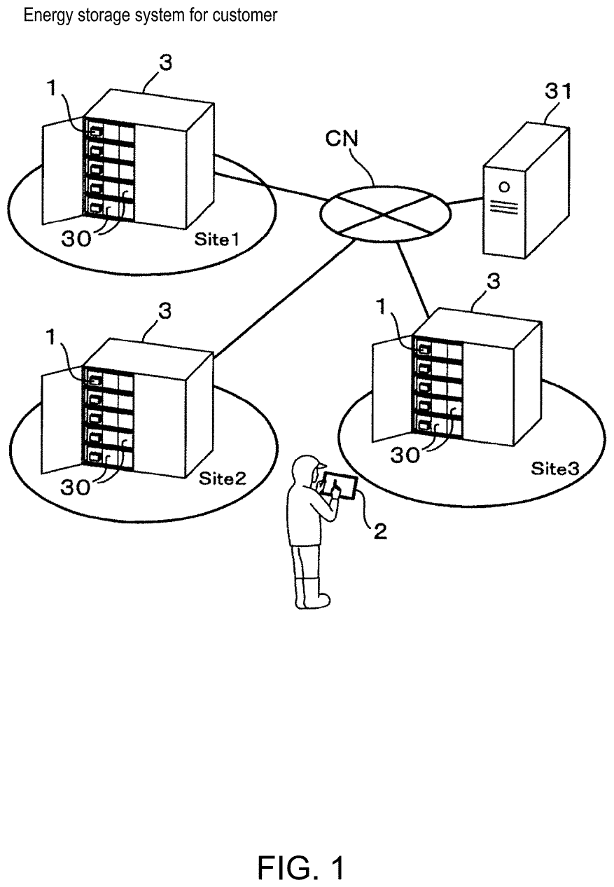

FIG. 1 illustrates an outline of a system to be maintained. A maintenance worker executes maintenance work using a network unit 1 and a maintenance terminal device 2. The network unit 1 is provided in an energy storage apparatus 3 including energy storage devices 30 to be maintained. The maintenance terminal device 2 is a device used by the maintenance worker.

The energy storage devices 30 to be maintained can be charged like secondary batteries including a lead-acid battery and a lithium ion battery or capacitors. Some of the energy storage devices 30 may be an unchargeable primary battery. In this embodiment, the energy storage devices 30 are energy storage modules in which a plurality of energy storage cells are connected to each other. The energy storage devices 30 may be energy storage cells themselves or energy storage module groups in which a plurality of energy storage modules are connected. The energy storage devices 30 may be lead-acid batteries.

Specifically, the energy storage apparatus 3 is an energy storage module group in an energy storage system. In the example of FIG. 1, the energy storage apparatuses 3 are installed at three different locations (Sites 1 to 3). The energy storage apparatus 3 may be an uninterruptible power system (UPS: uninterruptible power supply). The energy storage apparatus 3 may be a rectifier (d.c. power supply or a.c. power supply) disposed in a railway stabilized power supply system or the like. The network unit 1 may be mounted on a power conditioning system (PCS) that appropriately converts power obtained by a solar power generating system and outputs the converted power to a power storage module group or a power supply destination.

The network unit 1 is provided in the energy storage apparatus 3 in order to collect the state data of the energy storage devices 30 included in the energy storage apparatus 3 in the management device 31 managed by a customer and grasp the state of the energy storage apparatus 3. The network unit 1 is connected to a battery management unit (BMU) included in the energy storage device 30. The energy storage apparatus 3 is connected to a customer network CN managed by a customer (user) of the energy storage device 30 by the network unit 1. The customer network CN may be either a wired communication line or a wireless communication line. The energy storage apparatus 3 causes the network unit 1 to transmit the state data of the energy storage device 30 acquired by the BMU to the management device 31. The state data includes at least a voltage value of the energy storage device 30. The state data may include an internal resistance value, a current value, and a temperature.

A customer grasps a state of the energy storage apparatus 3, and a manufacturer or a vendor of the energy storage devices 30 performs periodic maintenance and inspection on the energy storage devices 30. This is for preventive maintenance for long-term operation of a system including the energy storage devices 30. The manufacturer or the vendor performs maintenance and inspection using the network unit 1 and the maintenance terminal device 2.

The maintenance worker goes to a customer management area where the energy storage apparatus 3 is installed while bringing the maintenance terminal device 2. The maintenance worker communicably connects the maintenance terminal device 2 to the network unit 1 in the customer management area. As described above, the network unit 1 is connected to the customer network CN. When the network unit 1 is disconnected from the customer network CN in order to be connected to the maintenance terminal device 2, transmission of the state data from the energy storage apparatus 3 to the management device 31 is stopped. The network unit 1 includes a wireless communication unit for performing communication connection with the maintenance terminal device 2 through a wireless communication line independent of the customer network CN. Accordingly, the maintenance terminal device 2 can establish communication connection with the network unit 1 without stopping transmission of the state data to the management device 31.

The communication connection between the maintenance terminal device 2 and the wireless communication unit needs to be valid only when the maintenance worker goes to the customer management area. When the wireless communication unit is unnecessarily enabled, a risk of an unjust connection to the energy storage apparatus 3 via the wireless communication unit increases. The wireless communication unit that is not used is preferably disabled.

When the unused wireless communication unit is enabled, the maintenance worker may connect the maintenance terminal device 2 to the customer network CN and instruct the network unit 1 via the customer network CN. However, the network unit 1 and the energy storage apparatus 3 provided with the network unit 1 are managed by a customer who purchases or rents the energy storage device 30. It should be avoided to connect the maintenance terminal device 2 of the maintenance worker to the customer network CN.

When the customer network CN is a wireless communication line, the energy storage apparatus 3 can perform communication connection with the management device 31 via the wireless communication unit. The communication management device (router, DHCP server) of the customer allocates the IP address of the network unit 1 in the customer network CN to the wireless communication unit, so that the management device 31 can perform communication connection with the network unit 1 via the wireless communication unit. Also in this case, in order for the maintenance terminal device 2 to be connected to the network unit 1, it is necessary to connect the maintenance terminal device 2 to the customer network CN. However, it should be avoided to connect the maintenance terminal device 2 to the customer network CN.

Since the maintenance terminal device 2 and the wireless communication unit of the network unit 1 are connected by a wireless communication line independent of the customer network CN only at the time of maintenance work, the wireless communication unit in the present embodiment temporarily functions as an access point. A configuration and processing for temporarily enabling the wireless communication unit will be described below.

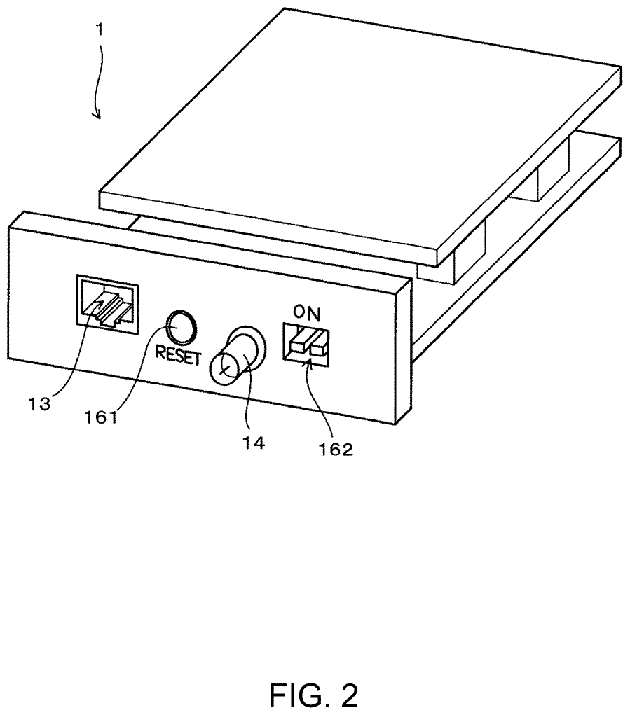

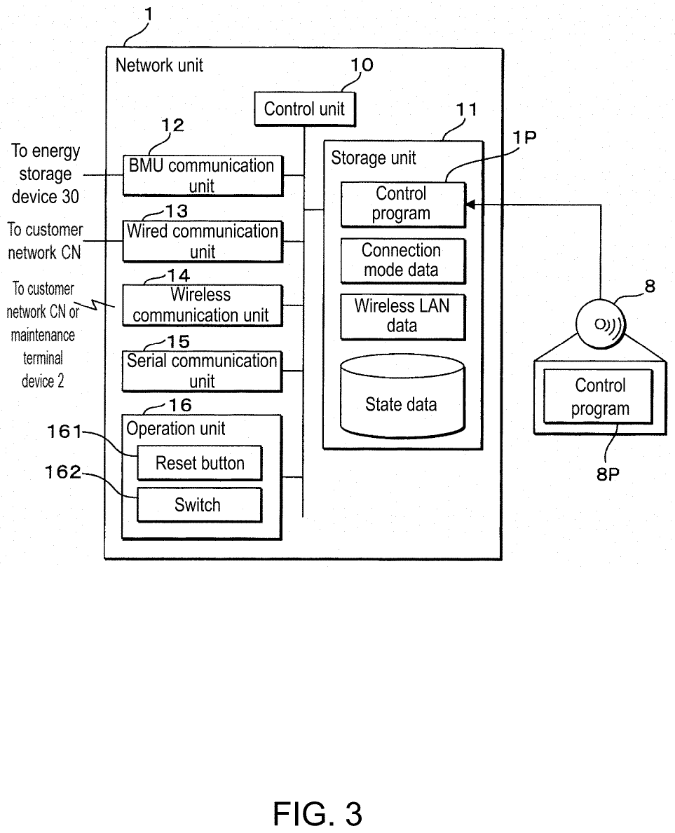

FIG. 2 illustrates an appearance of the network unit 1, and FIG. 3 illustrates a configuration of the network unit 1. The network unit 1 is a network card type communication device. The network unit 1 includes a control unit 10, a storage unit 11, a BMU communication unit 12, a wired communication unit 13, a wireless communication unit 14, a serial communication unit 15, and an operation unit 16.

The control unit 10 is a microprocessor using a central processing unit (CPU). The control unit 10 executes processing by controlling each component using built-in memories such as a read only memory (ROM) and a random access memory (RAM). The ROM of the memory stores a predetermined control program 1P, connection mode data, and wireless LAN data. The control program 1P includes a program for communication processing to be described later, a program for acquisition processing of measurement data of the energy storage device 30, and a web server program. The control program 1P may be obtained by the control unit 10 reading a control program 8P stored in a recording medium 8 and copying the control program 8P to the storage unit 11.

The storage unit 11 uses a non-volatile memory such as a flash memory. The storage unit 11 stores state data received from the energy storage device 30 via the BMU.

The BMU communication unit 12 is a communication interface that realizes communication with the BMU of the energy storage device 30 to which the network unit 1 is connected. The BMU communication unit 12 is a serial communication interface such as an RS-232 C or an RS-485.

The wired communication unit 13 is a communication device that realizes communication connection when the customer network CN is wired. The wired communication unit 13 functions as a second communication unit when the customer network CN is wired. The wired communication unit 13 includes a connection interface corresponding to the standard of the customer network CN. The customer network CN is, for example, Ethernet (registered trademark). The customer network CN may be an optical line. The customer network CN may be a network compatible with ECHONET/ECHONET Lite (registered trademark). The network unit 1 transmits the state data acquired from the energy storage device 30 via the BMU communication unit 12 to the management device 31 by the wired communication unit 13.

The wireless communication unit 14 is a wireless communication device for communication based on a wireless LAN. As illustrated in FIG. 2, the wireless communication unit 14 includes an antenna attachment interface, and the antenna may be externally attached. The wireless communication unit 14 may be a wireless communication device compatible with Bluetooth (registered trademark). When the customer network CN is wireless, the wireless communication unit 14 may function as a second communication unit, and the control unit 10 may transmit the state data to the management device 31 by the wireless communication unit 14.

The wireless communication unit 14 is used as a third communication unit for performing communication connection with the maintenance terminal device 2 via a communication medium different from the customer network CN when the maintenance worker performs an inspection. When connecting the maintenance terminal device 2 to the network unit 1 using the wireless communication unit 14, the maintenance worker may attach an external antenna only at the time of use.

The BMU communication unit 12 connected to the BMU of the energy storage device 30, the wired communication unit 13, and the wireless communication unit 14 have different hardware. However, the functions of these three communication units may be achieved by the same hardware as long as individual communication connections can be made according to the communication protocol with each connection destination. For example, when the customer network CN is wireless, the functions of both the second communication unit and the third communication unit may be achieved by the wireless communication unit 14. In this case, the network unit 1 may not include the wired communication unit 13.

The serial communication unit 15 is an external serial communication device. The serial communication unit 15 includes a connection interface for serial communication. The serial communication unit 15 is, for example, a universal serial bus (USB) interface. The network unit 1 initially acquires setting data from the maintenance terminal device 2 or another device by the serial communication unit 15. The serial communication unit 15 is not essential.

The operation unit 16 includes a reset button 161 and a switch 162. The reset button 161 causes the control unit 10 to generate reset interruption. When the reset button 161 is pressed, the control unit 10 detects this, restarts, and starts processing based on the control program 1P stored in the memory.

The switch 162 is a changeover switch. The switch 162 includes one or a plurality of dip switches. As illustrated in FIG. 2, the network unit 1 includes, for example, two dip switches. The control unit 10 acquires a maximum of four switch states by two dip switches. The number of dip switches is not limited to two, and may be only one or three or more. Correspondence between the switch state and the connection mode data is stored in the memory. The control unit 10 acquires the switch state at the time of activation, and controls each component according to the connection mode data corresponding to the acquired switch state. The switch 162 is not limited to a dip switch, and may be a switch of another aspect.

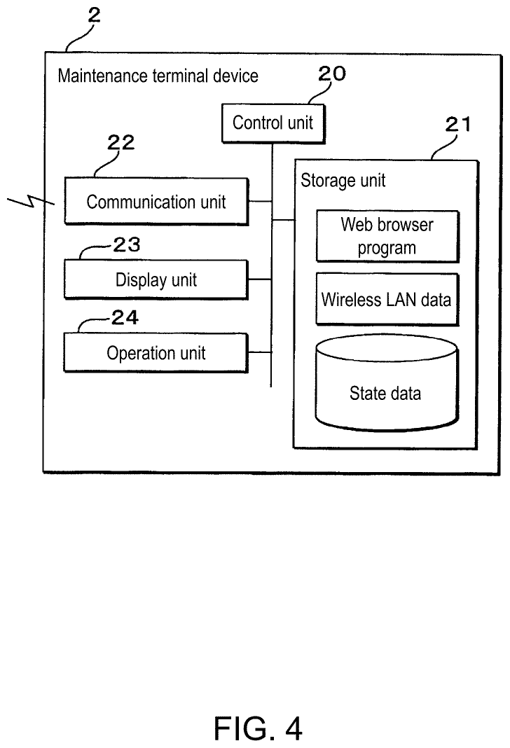

FIG. 4 is a block diagram illustrating a configuration of the maintenance terminal device 2. The maintenance terminal device 2 may be a desktop or laptop personal computer. The maintenance terminal device 2 may be a so-called smartphone or tablet type communication terminal. The maintenance terminal device 2 includes a control unit 20, a storage unit 21, a communication unit 22, a display unit 23, and an operation unit 24.

The control unit 20 is a processor using a CPU or a graphics processing unit (GPU). The control unit 20 can access data provided by the network unit 1 functioning as a web server based on a web browser program stored in the storage unit 21.

As the storage unit 21, for example, a non-volatile memory such as a hard disk, a flash memory, or a solid state drive (SSD) is used. The storage unit 21 stores data to be referred to by the control unit 20. The storage unit 21 stores various programs including the web browser program. The storage unit 21 stores the state data acquired from the network unit 1. The storage unit 21 stores wireless LAN data for performing communication connection with the network unit 1. The wireless LAN data includes an SSID and a password of the access point.

The communication unit 22 is a communication device for realizing data communication via a public communication network or a carrier network. The communication unit 22 includes a wireless LAN compatible communication device corresponding to the wireless communication unit 14 of the network unit 1. When the network unit 1 functions as an access point, the control unit 20 can perform communication connection with the network unit 1 by the communication unit 22. Conversely, the communication unit 22 may function as an access point and receive communication connection from the network unit 1. The communication unit 22 may include a network card for wired communication and a wireless communication device compatible with a carrier network for mobile communication.

The display unit 23 is a display such as a liquid crystal display or an organic electro luminescence (EL) display. The display unit 23 displays an image of a web page provided from the network unit 1. The display unit 23 may be a touch panel built-in display.

The operation unit 24 is a user interface such as a keyboard and a pointing device capable of inputting and outputting to and from the control unit 20. The operation unit 24 may be a voice input unit. The operation unit 24 may be a touch panel of the display unit 23. The operation unit 24 may be a physical button. The operation unit 24 notifies the control unit 20 of operation data by the maintenance worker.

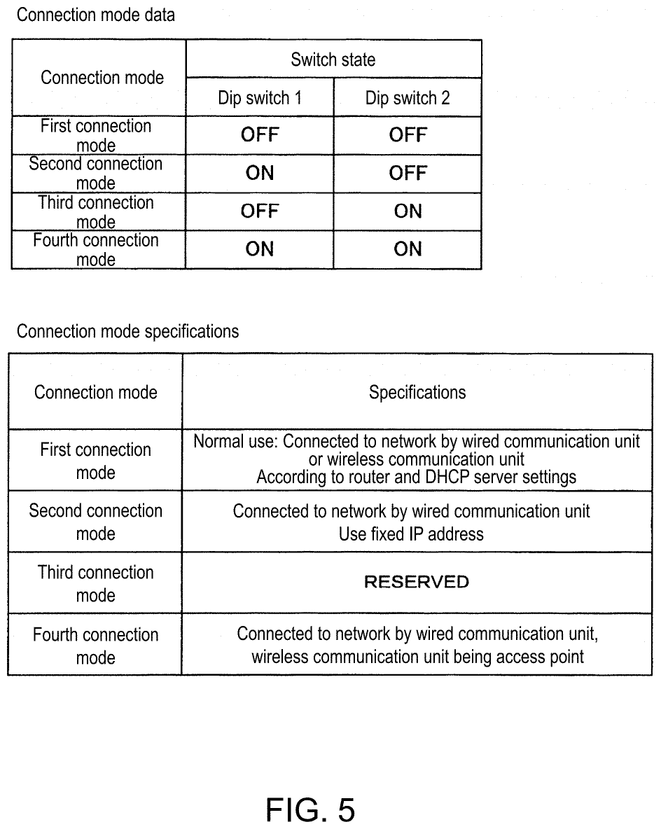

A connection mode set to temporarily enable the wireless communication unit 14 will be described. FIG. 5 illustrates an example of the connection mode. Four connection modes are prepared according to the configuration of the switch 162. The memory of the control unit 10 stores the correspondence between the connection mode illustrated in FIG. 5 and the state of the switch 162 as connection mode data.

A first connection mode is a mode for communication via the customer network CN. The first connection mode is normally used during operation of the energy storage apparatus 3. In the case of the first connection mode, the wired communication unit 13 and the wireless communication unit 14 are connected to the customer network CN based on the setting by a customer. When the customer network CN is wired, the network unit 1 is connected to the customer network CN by the wired communication unit 13. When the customer network CN is a wireless communication line, the network unit 1 is connected to the customer network CN by the wireless communication unit 14. In the first connection mode, the wired communication unit 13 or the wireless communication unit 14 performs communication connection with another communication device by the address allocated to the router and the DHCP server of the customer network CN. In the first connection mode, the wireless communication unit 14 may be disabled.

A second connection mode is a mode for communication via the customer network CN. The second connection mode is used in a specific case during operation of the energy storage apparatus 3. In the case of the second connection mode, the network unit 1 is connected to the customer network CN which is a wired line with a preset fixed IP address by the wired communication unit 13. In the case of the second connection mode, the network unit 1 may be connected to another wireless communication line managed by the customer based on the setting of the customer by the wireless communication unit 14. In the second connection mode, the wireless communication unit 14 may be disabled.

A third connection mode is a spare mode for a manufacturer or a vendor of the energy storage device 30 to use. The third connection mode is prepared for communication conditions set afterwards.

A fourth connection mode is a mode for the network unit 1 for performing communication connection with the maintenance terminal device 2. In the fourth connection mode, while the network unit 1 is connected to the customer network CN, which is a wired communication line, by the wired communication unit 13 based on the setting of the customer, the wireless communication unit 14 functions as an access point for the maintenance terminal device 2. The wireless communication unit 14 outputs a radio wave including an SSID stored in advance, and establishes communication connection with a communication device that knows a password corresponding to the SSID. In the fourth connection mode, the network unit 1 continues transmission of the state data to the management device 31 by the wired communication unit 13. Conversely, the setting may be made such that the communication unit 22 of the maintenance terminal device 2 functions as an access point, and the network unit 1 functions as a client.

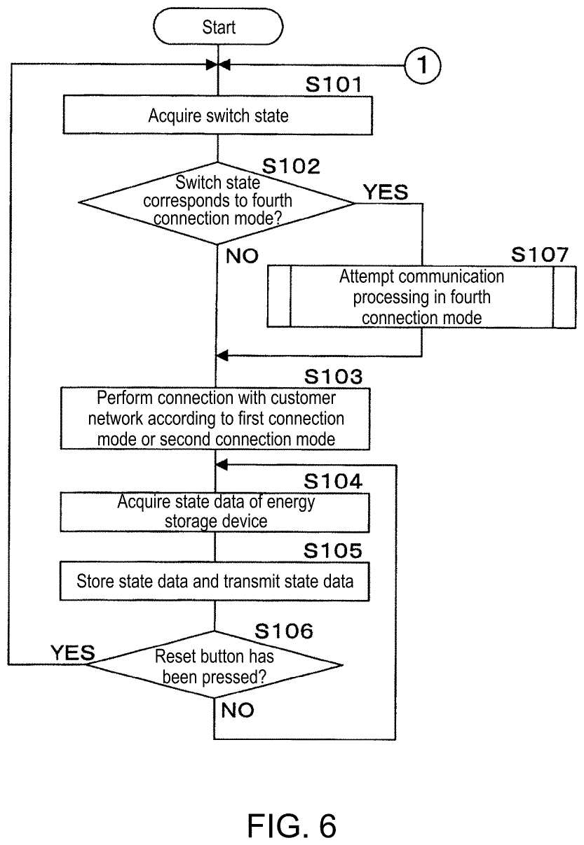

FIG. 6 is a flowchart illustrating an example of a processing procedure of the network unit 1. When receiving power supply from a power supply unit (not illustrated), the control unit 10 starts the following processing based on the control program 1P. The control unit 10 continues the following processing until the power supply is stopped.

The control unit 10 acquires the state of the switch 162 (step S101). The control unit 10 determines whether or not the switch state corresponds to the fourth connection mode (step S102).

When it is determined that the switch state does not correspond to the fourth connection mode (S102: NO), the control unit 10 performs communication connection with the customer network CN according to the first connection mode or the second connection mode (step S103).

The control unit 10 acquires the state data of the energy storage device 30 from the BMU communication unit 12 (step S104). The control unit 10 stores the acquired state data in the storage unit 11 and transmits the state data from the valid wired communication unit 13 or wireless communication unit 14 to the management device 31 (step S105).

The control unit 10 determines whether or not the reset button 161 has been pressed (step S106). When it is determined that the reset button 161 has not been pressed (S106: NO), the control unit 10 returns the processing to step S104. The control unit 10 continues the acquisition and transmission of the state data of the energy storage device 30.

When it is determined that the reset button 161 has been pressed (S106: YES), the control unit 10 returns the processing to step S101.

When it is determined that the switch state corresponds to the fourth connection mode (S102: YES), the control unit 10 attempts communication processing in the fourth connection mode (step S107). In principle, the control unit 10 returns the processing to step S103 after executing the communication processing in the fourth connection mode.

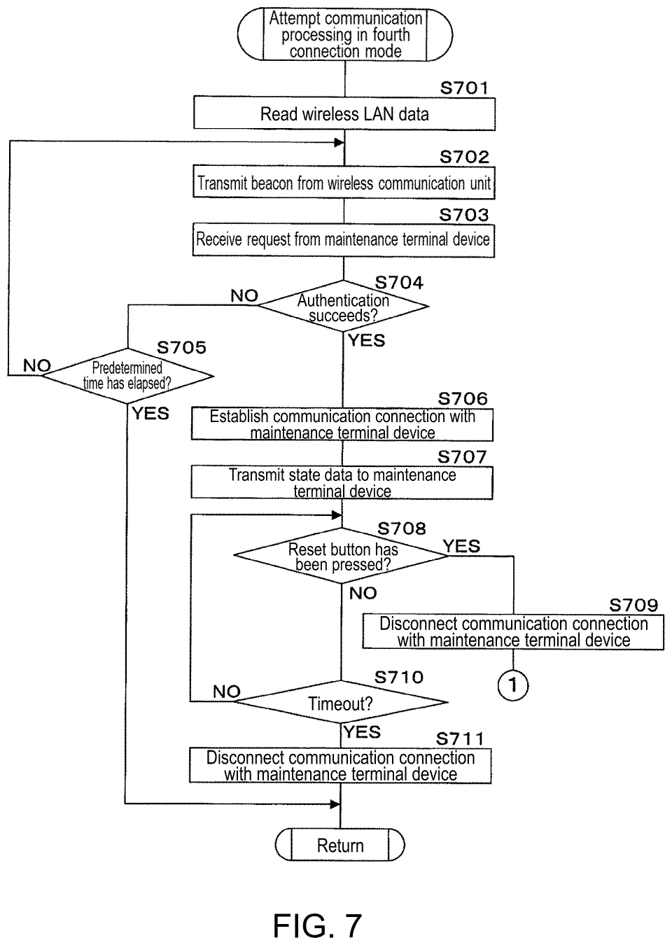

FIG. 7 is a flowchart illustrating an example of a procedure of the communication processing in the fourth connection mode. FIG. 7 corresponds to details of the communication processing in step S107 illustrated in FIG. 6.

The control unit 10 reads the wireless LAN data (SSID and corresponding password) stored in advance in the memory (step S701).

The control unit 10 transmits a beacon from the wireless communication unit 14 and a wireless antenna (step S702). The control unit 10 receives a request including the SSID matching the SSID read in step S701 from the maintenance terminal device 2 (step S703). When the request cannot be received, the control unit 10 may advance the processing to step S705.

The control unit 10 determines whether or not the authentication based on the password read in step S701 succeeds with respect to the maintenance terminal device 2 which is the transmission source of the request (step S704).

When it is determined that the authentication has failed (S704: NO), it is determined whether or not a predetermined time has elapsed (step S705). When it is determined that the predetermined time has not elapsed (S705: NO), the control unit 10 returns the processing to step S702.

When it is determined that the predetermined time has elapsed (S705: YES), the control unit 10 returns the processing to step S103 of FIG. 6. In this case, the control unit 10 stops the communication in the fourth connection mode and connects the wired communication unit 13 or the wireless communication unit 14 to the customer network CN according to the first connection mode.

When it is determined that the authentication has succeeded within the predetermined period (S704: YES), the control unit 10 establishes communication connection with the maintenance terminal device 2 which is the transmission source of the request (step S706). The control unit 10 transmits the state data accumulated in the storage unit 11 to the maintenance terminal device 2 to which the control unit 10 is communicably connected (step S707). The control unit 10 may receive an access from the maintenance terminal device 2 as a web server and transmit web page data.

The control unit 10 determines whether or not the reset button 161 has been pressed (step S708). When it is determined that the reset button 161 has been pressed (S708: YES), the control unit 10 disconnects the communication connection by the wireless communication unit 14 (step S709), returns the processing to step S101 in FIG. 6, and starts processing similar to that at the time of activation. If the state of the switch 162 has changed before the reset button 161 is pressed, the control unit 10 executes processing according to the changed switch state.

When it is determined that the reset button 161 has not been pressed (S708: NO), the control unit 10 determines whether or not the time from the activation in the fourth connection mode has exceeded a predetermined timeout period (step S710). The timeout period is a period of time, such as one hour, in which time required for maintenance work time is relaxed. The memory of the control unit 10 stores the timeout period.

When it is determined that the time from the activation in the fourth connection mode has not exceeded the predetermined timeout period (S710: NO), the control unit 10 returns the processing to step S708. The control unit 10 maintains the communication connection with the maintenance terminal device 2 until the reset button 161 is pressed or the timeout period elapses. During this period, the control unit 10 may continue transmission of the state data in response to a request from the maintenance terminal device 2. The control unit 10 may receive an instruction to the network unit 1 from the maintenance terminal device 2 by the function of the web server of the network unit 1.

When the time from the activation in the fourth connection mode has exceeded the predetermined timeout period (S710: YES), the control unit 10 disconnects the communication connection by the wireless communication unit 14 (step S711). The control unit 10 returns the processing to step S103 in FIG. 6. The control unit 10 is connected to the customer network CN according to the first connection mode. Even if the maintenance worker forgets to return the state of the switch 162 to the state before the maintenance work, the network unit 1 is connected the customer network CN in the first connection mode.

When the maintenance worker goes to a customer's management area where the energy storage device 30 is used for maintenance and inspection, the maintenance worker performs the maintenance work according to the following procedure. The maintenance worker carries the maintenance terminal device 2 in which the SSID and the password corresponding to the network unit 1 are stored in advance, and goes to the maintenance work place. With the permission of the customer, the maintenance worker causes the switch 162 of the network unit 1 of the energy storage apparatus 3 including the energy storage device 30 to be maintained to correspond to the fourth connection mode in the presence of the customer. Specifically, the maintenance worker turns on all the dip switches of the switch 162. The maintenance worker presses the reset button 161 of the network unit 1 in a state where the switch 162 corresponds to the fourth connection mode. As a result, the network unit 1 can perform communication connection via the customer network CN and communication connection through a communication line independent of the customer network CN.

The maintenance worker operates the display unit 23 and the operation unit 24 of the maintenance terminal device 2 to attempt communication connection with the network unit 1 functioning as an access point. The maintenance terminal device 2 can output candidates of the connectable network unit 1 to the display unit 23 according to the SSID included in the beacon from the network unit 1. When one of the candidates is selected by the operation unit 24, the maintenance terminal device 2 transmits a request to the selected network unit 1. Accordingly, communication connection between the target network unit 1 and the maintenance terminal device 2 carried by the maintenance worker is established.

When the communication connection is established, the maintenance terminal device 2 automatically acquires the state data of the energy storage device 30 via the network unit 1 and stores the acquired state data in the storage unit 21. The control unit 20 of the maintenance terminal device 2 may store the state data in the storage unit 21 together with identification data of the energy storage device 30 or identification data of the network unit 1.

When the acquisition of the state data by the maintenance terminal device 2 is completed, the maintenance worker returns the switch 162 to the state corresponding to the first or second connection mode, and presses the reset button 161. The network unit 1 is connected to the customer network CN in the first or second connection mode, and returns to a normal mode in which acquisition and transmission of the state data are continued.

As described above, the network unit 1 realizes communication connection with the specific maintenance terminal device 2 while maintaining connection to the customer network CN. The maintenance terminal device 2 can be easily connected to the network unit 1 and is not connected to the customer network CN. As a result, the maintenance worker can work smoothly and safely for the customer network CN.

In the above example, the network unit 1 performs communication connection with the maintenance terminal device 2 by the wireless communication unit 14. However, the present invention is not limited to wireless communication. In the fourth connection mode, the network unit 1 may perform P2P communication with the maintenance terminal device 2 with a preset IP address by the wired communication unit 13 while continuing transmission to the state data to the management device 31 by the wireless communication unit 14.

The embodiment disclosed as described above is illustrative in all respects and is not restrictive. The scope of the present invention is defined by the claims, and includes meanings equivalent to the claims and all modifications within the scope.

### DESCRIPTION OF REFERENCE SIGNS

1: network unit
10: control unit
11: storage unit
12: BMU communication unit
13: wired communication unit
14: wireless communication unit
16: operation unit
161: reset button
162: switch
1P: control program
2: maintenance terminal device
23: display unit
3: energy storage apparatus
30: energy storage device
CN: customer network

1. A network unit comprising:
a first communication unit that receives state data from a unit that measures a state of an energy storage device;
a second communication unit that performs communication via a specific network;
a third communication unit that performs communication via a communication medium different from the specific network;
an operation unit including a changeover switch; and
a control unit that controls communication by the first to third communication units,
wherein the control unit transmits the state data from the second communication unit according to a setting in the specific network according to a state of the changeover switch, and
when the network unit is activated with the changeover switch being in a predetermined state, the control unit performs communication connection with a specific communication device by the third communication unit.

2. The network unit according to claim 1, wherein
the operation unit includes a reset button that causes interruption to the control unit, and
the control unit determines whether or not the state of the changeover switch is the predetermined state every time interruption occurs by pressing of the reset button.

3. The network unit according to claim 1, wherein when a predetermined timeout period has elapsed after the network unit is activated with the changeover switch being in the predetermined state, the control unit transitions to a state of performing communication according to the setting by the second communication unit.

4. The network unit according to claim 1, wherein when the network unit is activated with the changeover switch being in the predetermined state, the control unit causes the third communication unit to function as an access point to communicably connect with a communication device that transmits a valid password.

5. A maintenance system comprising:
a network unit that receives state data from a unit that measures a state of an energy storage device by a first communication unit and transmits the state data to another unit; and
a maintenance terminal device including a communication unit that performs communication connection with the network unit,
wherein the network unit includes:
a second communication unit that performs communication via a specific network;
a third communication unit that performs communication via a communication medium different from the specific network;
an operation unit including a changeover switch; and
a control unit that controls communication by the first to third communication units,
the control unit transmits the state data from the second communication unit or the third communication unit according to a setting in the specific network according to a state of the changeover switch, and
only when the network unit is activated with the changeover switch being in a predetermined state, the control unit performs communication connection with the maintenance terminal device by the third communication unit without following the setting, and transmits the state data to the maintenance terminal device.

6. A non-transitory computer readable medium storing a computer program causing a computer including a communication unit that performs communication via a wired communication line and/or a wireless communication medium, and an operation unit including a changeover switch to execute processing of:
while receiving state data from a unit that measures a state of an energy storage device, transmitting the state data from the communication unit according to a setting in a specific network according to a state of the changeover switch;
performing communication connection with a specific communication device via a communication medium different from the specific network without following the setting only when activation is performed with the changeover switch being in a predetermined state; and
transmitting the state data to the specific communication device.

7. An energy storage device data transmission method in which a network unit including a communication unit that performs communication via a wired communication line and/or a wireless communication medium, and an operation unit including a changeover switch receives state data from a unit that measures a state of an energy storage device and transmits the state data to another unit, the method comprising processing of, by the network unit:
transmitting the state data from the communication unit to a specific network according to a setting in the specific network according to a state of the changeover switch;
performing communication connection with a specific communication device via a communication medium different from the specific network without following the setting when the network unit is activated with the changeover switch being in a predetermined state; and
transmitting the state data to the specific communication device.
